(19) United States
(12) Patent Application Publication
(10) Pub. No.: US 2007/0169022 A1
(43) Pub. Date: Jul. 19, 2007

(54) PROCESSOR HAVING MULTIPLE INSTRUCTION SOURCES AND EXECUTION MODES

(76) Inventors: Anthony Mark Jones, Beaverton, OR (US); Paul M. Wasson, Beaverton, OR (US); Michael R. Butts, Beaverton, OR (US)

Correspondence Address: AMBRIC, INC.;C/O MARGER JOHNSON & MCCOLLOM PC, 210 SW MORRISON STREET, SUITE 400, PORTLAND, OR, 97204, US

(21) Appl. No.: 11/672,450

(22) Filed: Feb. 7, 2007

Related U.S. Application Data
(63) Continuation-in-part of application No. 10/871,347, filed on Jun. 18, 2004, now Pat. No. 7,206,870.
(63) Continuation-in-part of application No. 11/458,061, filed on Jul. 17, 2006.
(60) Provisional application No. 60/479,759, filed on Jun. 18, 2003.
(60) Provisional application No. 60/790,912, filed on Apr. 10, 2006.
(60) Provisional application No. 60/836,036, filed on Aug. 7, 2006.

(51) Int. Cl. G06F 9/45

(52) U.S. Cl. 717/136

(57) ABSTRACT

A processor includes the standard mode of executing instructions from stored memory as well as a mode of executing from a separate instruction source. A programmable selector determines the source, and may be automatically programmed dependent on particular instructions. Streaming instructions from outside the processor provides an ability to have infinite program space. Further, booting processors in such an execution mode allows systems to be configured from external sources.

### CROSS REFERENCE TO RELATED APPLICATIONS

This application is a continuation-in-part of co-pending U.S. application Ser. No. 10/871,347, filed Jun. 18, 2004, entitled DATA INTERFACE FOR HARDWARE OBJECTS, which in turn claims the benefit of U.S. provisional application 60/479,759, filed Jun. 18, 2003, entitled INTEGRATED CIRCUIT DEVELOPMENT SYSTEM. This application is also a continuation-in-part of co-pending U.S. application Ser. No. 11/458,061, filed Jul. 17, 2006, entitled SYSTEM OF VIRTUAL DATA CHANNELS ACROSS CLOCK BOUNDARIES IN AN INTEGRATED CIRCUIT. Additionally this application claims the benefit of US provisional application 60/790,912, filed Apr. 10, 2006, entitled MIND COMPUTING FABRIC, and of U.S. provisional application 60/836,036, filed Aug. 20, 2006, entitled RECONFIGURABLE PROCESSOR ARRAY. The teachings of all of these applications are explicitly incorporated by reference herein.

### TECHNICAL FIELD

This disclosure relates to an integrated circuit, and, more particularly, to a processor that has multiple sources of instructions and multiple methods of execution.

### BACKGROUND

Processors are well known. Processor and microprocessor are generic terms for an integrated circuit that can perform operations for a wide range of applications. They are the central computing units for computers and many other devices.

FIG. 1 illustrates standard components of a simple microprocessor 20. Microprocessor 20 includes an internal data bus 22 connected to a set of data buffers 24. The data buffers 24 transfer data and instructions across the internal bus 22 into a random access memory (RAM) 40 for use by the microprocessor 20. Also coupled to the RAM 40 is an instruction register 26, which temporarily stores an instruction for the microprocessor 20.

In operation, the instructions are fetched from the instruction register 26 into an instruction decoder 28, which determines a sequence of micro-operations that the microprocessor 20 performs to complete the instruction. The actual execution is performed in an execution unit 30, which may include one or more Arithmetic Logic Units (ALUs) 32. A set of registers 34 is coupled to the instruction decoder 28, the execution unit 30, and the internal bus 22. A program counter 38 keeps track of which instruction will be used next and accepts inputs from both the instruction decoder 28 and the execution unit 30. Timing and control of the microprocessor 20 is performed by a timing/control block 36.

Newer processors may include vastly expanded execution units, for instance units having very deep stage instruction pipelines. Other variations such as multiple internal buses and expanded memories (including multi-level cache memories) may also be present. Though these other options may be present, the standard components and structure of the instruction register and decode remain unchanged in standard processors.

Embodiments of the invention address these and other limitations in the prior art.

### BRIEF DESCRIPTION OF THE DRAWINGS

FIG. 1 is a block diagram of a conventional simple microprocessor.

FIG. 2 is a block diagram of an integrated circuit platform formed of a central collection of tessellated operating units surrounded by I/O circuitry according to embodiments of the invention.

FIG. 3 is a block diagram illustrating several groups of processing units used to make the operating units of FIG. 2 according to embodiments of the invention.

FIG. 4 is a block diagram of a data/protocol register used to connect various components within and between the processing units of FIG. 3.

FIG. 5 is a block diagram of details of an example compute unit illustrated in FIG. 3 according to embodiments of the invention.

FIG. 6 is a block diagram of an example processor included in the compute unit of FIG. 5.

FIG. 7 is an example flow diagram illustrating methods of switching execution modes in a processor according to embodiments of the invention.

### DETAILED DESCRIPTION

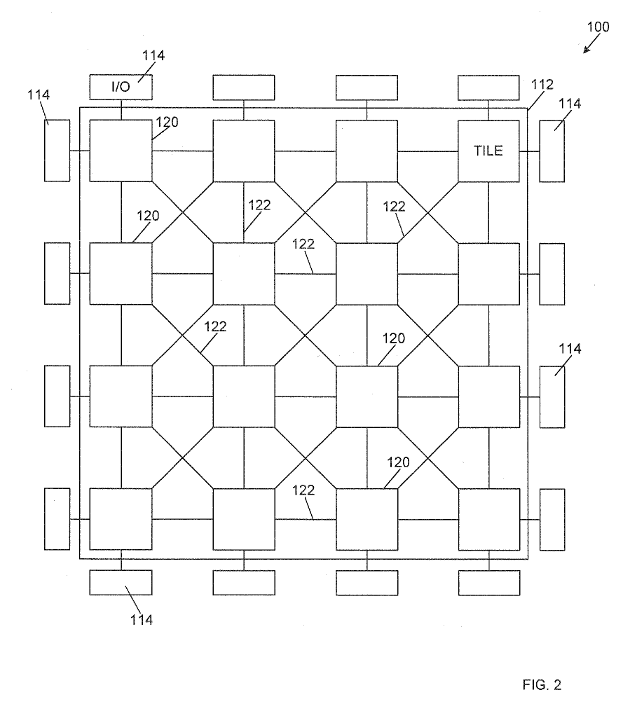

FIG. 2 illustrates an example tessellated multi-element processor platform 100 according to embodiments of the invention. Central to the processor platform 100 is a core 112 of multiple tiles 120 that are arranged and placed according to available space and size of the core 112. The tiles 120 are interconnected by communication data lines 122 that can include protocol registers as described below.

Additionally, the platform 100 includes Input/Output (I/O) blocks 114 placed around the periphery of the platform 100. The I/O 114 blocks are coupled to some of the tiles 120 and provide communication paths between the tiles 120 and elements outside of the platform 100. Although the I/O blocks 114 are illustrated as being around the periphery of the platform 100, in practice the blocks 114 may be placed anywhere within the platform 100. Standard communication protocols, such as Peripheral Component Interface Express (PCIe), Dynamic Data Rate Two Synchronous Dynamic Random Access Memory interface (DDR2), or simple hardwired input/output wires, for instance, could be connected to the platform 100 by including particularized I/O blocks 114 structured to perform the particular protocols required to connect to other devices.

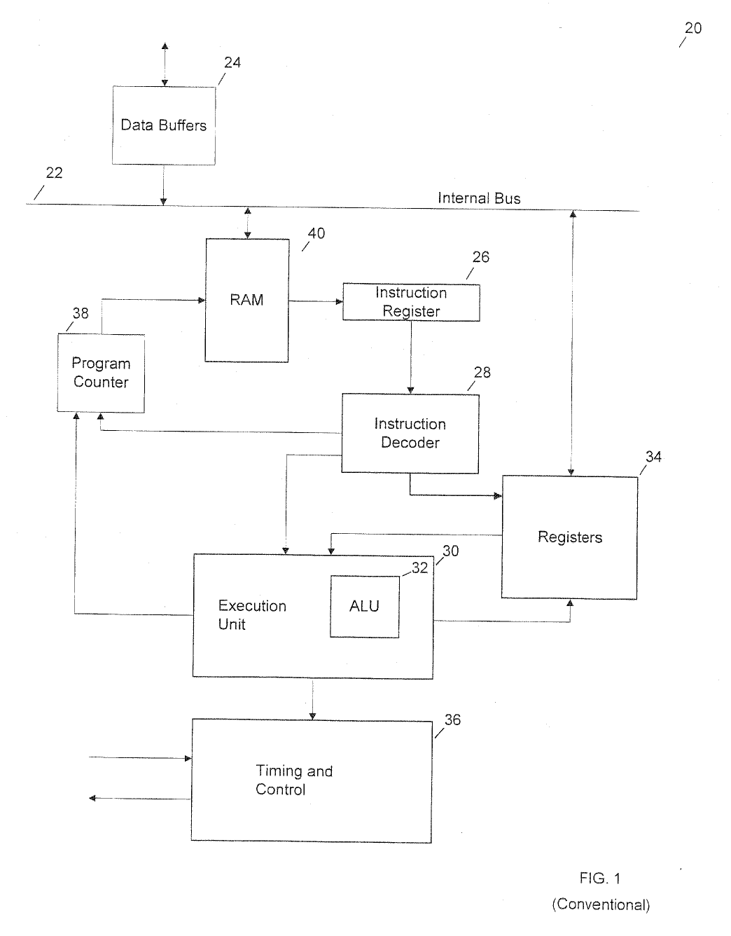

The number and placement of tiles 120 may be dictated by the size and shape of the core 112, as well as external factors, such as cost. Although only sixteen tiles 120 are illustrated in FIG. 2, the actual number of tiles placed within the platform 100 may change depending on multiple factors. For instance, as process technologies scale smaller, more tiles 120 may fit within the core 112. In some instances, the number of tiles 120 may be purposely be kept small to reduce the overall cost of the platform 100, or to scale the computing power of the platform 100 to desired applications. In addition, although the tiles 120 are illustrated as being equal in number in the horizontal and vertical directions, yielding a square platform 100, there may be more tiles in one direction than another, and may be shaped to accommodate additional, non tiled elements. Thus, platforms 100 with any number of tiles 120, even one, in any geometrical configuration are specifically contemplated. Further, although only one type of tile 120 is illustrated in FIG. 1, different types and numbers of tiles may be integrated within a single processor platform 100.

Tiles 120 may be homogeneous or heterogeneous. In some instances the tiles 120 may include different components. They may be identical copies of one another or they may include the same components packed differently.

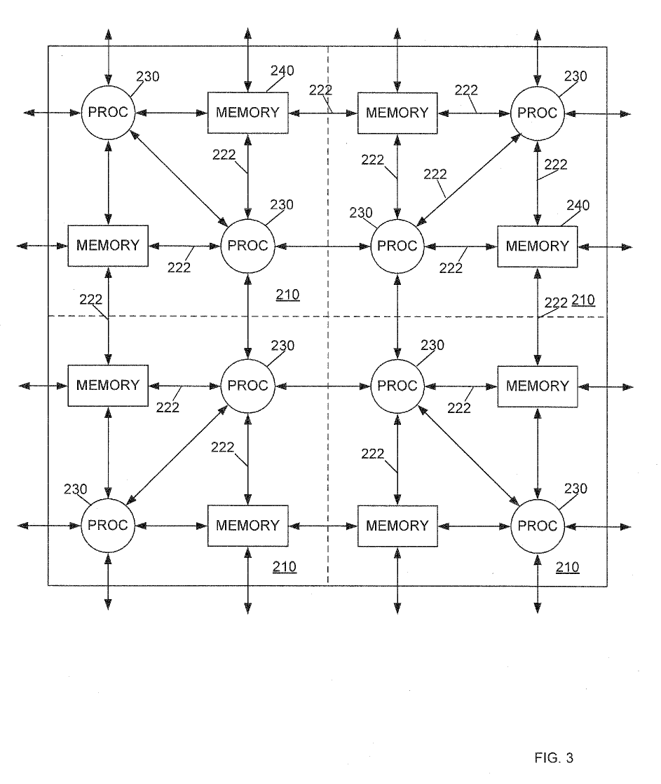

FIG. 3 illustrates components of example tiles 210 of the platform 100 illustrated in FIG. 2. In this figure, four tiles 210 are illustrated. The components illustrated in FIG. 3 could also be thought of as one, two, four, or eight tiles 120, each having a different number of processor-memory pairs. For the remainder of this document, however, a tile will be referred to as illustrated by the delineation in FIG. 3, having two processor-memory pairs. In the system described, there are two types of tiles illustrated, one with processors in the upper-left and lower-right corners, and another with processors in the upper-right and lower-left corners. Other embodiments can include different component types, as well as different number of components. Additionally, as described below, there is no requirement that the number of processors equal the number of memory units in each tile 210.

In FIG. 3, an example tile 210 includes processor or “compute” units 230 and “memory” units 240. The compute units 230 include mostly computing resources, while the memory units 240 include mostly memory resources. There may be, however, some memory components within the compute unit 230 and some computing components within the memory unit 240. In this configuration, each compute unit 230 is directly attached to one memory unit 240, although it is possible for any compute unit to communicate with any memory unit within the platform 100 (FIG. 2).

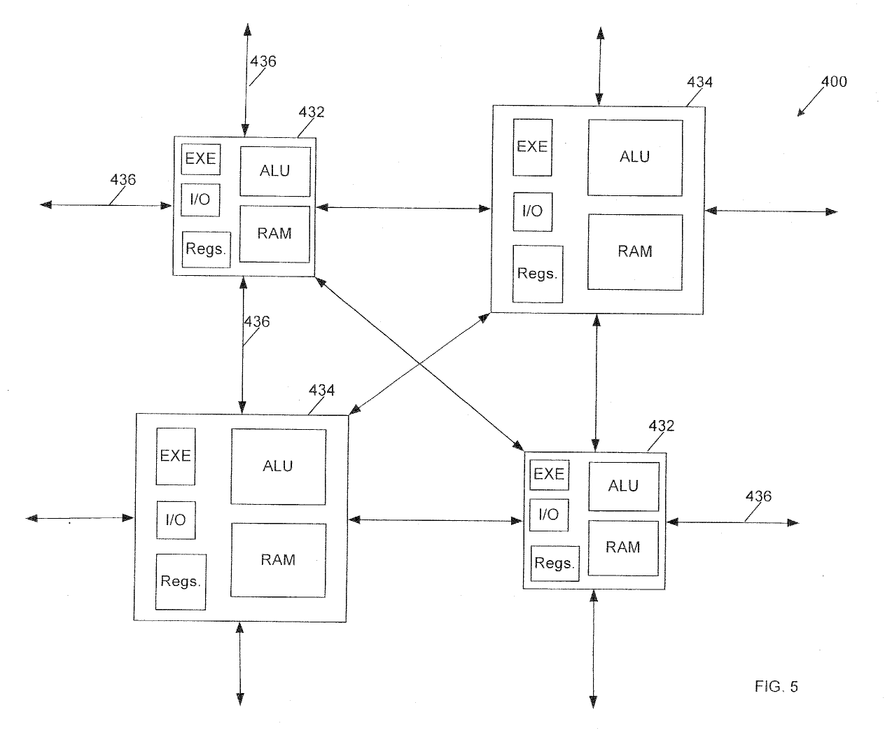

Data communication lines 222 connect units 230, 240 to each other as well as to units in other tiles. Detailed description of components with the compute units 230 and memory units 240 begins with FIG. 5 below.

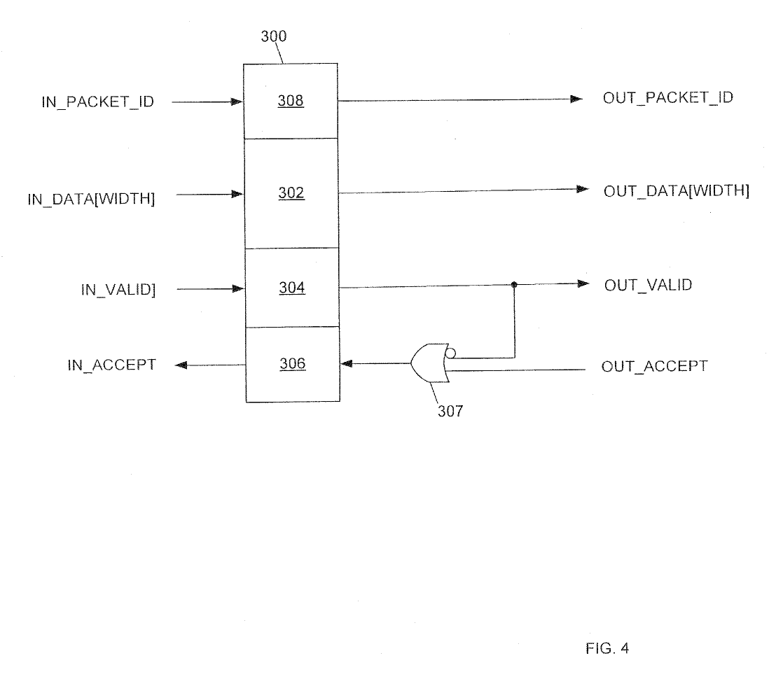

FIG. 4 is a block diagram illustrating a data/protocol register 300, the function and operation of which is described in U.S. application Ser. No. 10/871,347, referred to above. The register 300 includes a set of storage elements between an input interface and an output interface.

The input interface uses an accept/valid data pair to control the flow of data. If the valid and accept signals are both asserted, the register 300 moves data stored in sections 302 and 308 to the output datapath, and new data is stored in 302, 308. Further, if out_valid is de-asserted, the register 300 continues to accept new data, overwriting the invalid data in 302, 308. This push-pull protocol register 300 is locally self-synchronizing in that it only sends if the data is valid and the output datapath is ready to accept it. Likewise, if the protocol register 300 is not ready to take data, it de-asserts the in_accept signal, which informs the previous stages that the register 300 cannot take the next data value.

In some embodiments, the packet_id value stored in the section 308 is a single bit and operates to indicate that the data stored in the section 302 is in a particular packet, group or word of data. In a particular embodiment, a LOW value of the packet_id indicates that it is the last word in a message packet. All other words in the packet would have a HIGH value for packet_id. Thus the first word in a message packet can be determined by detecting a HIGH packet_id value that immediately follows a LOW value for the word that precedes the current word. Alternatively stated, the first HIGH value for the packet_id that follows a LOW value for a preceding packet_id indicates the first word in a message packet.

The width of the data storage section 302 can vary based on implementation requirements. Typical widths would include powers of two such as 4, 8, 16, and 32 bits.

With reference to FIG. 3, the data communication lines 222 could include a register 300 at each end of each of the communication lines. Because of the local self-synchronizing nature of register 300, additional registers 300 could be inserted anywhere along the communication lines without changing the operation of the communication.

FIG. 5 illustrates a set of example elements forming an illustrative compute unit 400 which could be the same or similar to the compute 230 of FIG. 3. In this example, there are two minor processors 432 and two major processors 434. The major processors 434 have a richer instruction set and include more local storage than the minor processors 432, and are structured to perform mathematically intensive computations. The minor processors 432 are more simple compute units than the major processors 434, and are structured to prepare instructions and data so that the major processors can operate efficiently and expediently.

In detail, each of the processors 432, 434 may include an execution unit, an Arithmetic Logic Unit (ALU), RAM, a set of Input/Output circuitry, and a set of registers. In an example embodiment, the RAM of the minor processors 432 may total 64 words of instruction memory while the major processors include 256 words, for instance.

Communication channels 436 may be the same or similar to the data communication lines 222 of FIG. 3, which may include the data registers 300 of FIG. 4.

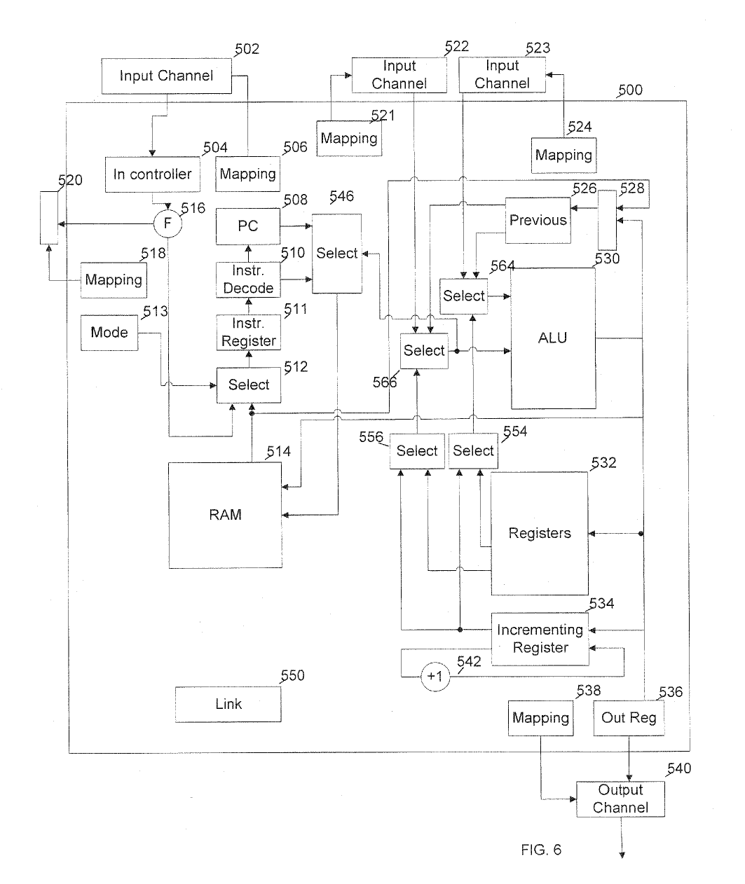

FIG. 6 illustrates an example processor 500 that could be an implementation of the minor processor 432 of FIG. 5.

Major components of the example processor 500 include input channels 502, 522, 523, output channels 520, 540. Channels may be the same or similar to those described in U.S. patent application Ser. No. 11/458,061, referred to above. Additionally the processor 500 includes an ALU 530, registers 532, internal RAM 514, and an instruction decoder 510. The ALU contains functions such as an adder, logical functions, and a multiplexer. The RAM 514 is a small local memory that can contain any mixture of instructions and data. Instructions may be 16 or 32 bits wide, for instance.

The processor 500 has two execution modes: Execute-From-Channel (channel execution) and Execute-From-Memory (memory execution), as described in detail below.

In memory execution mode, the processor 500 fetches and executes instructions from the RAM 514, which is the conventional mode of processor operation, as described with reference to FIG. 1 above. In memory execution mode, instructions are retrieved from the RAM 514, decoded in the decoder 510, and executed in a conventional manner by the ALU or other hardware in the processor 500.

In channel execution mode, the processor 500 operates on instructions sent by an external process that is separate from the processor 500. These instructions are transmitted to the processor 500 over an input channel, for example the input channel 502. The original source for the code transmitted over the channel 502 is very flexible. For example, the external process may simply stream instructions that are stored in an external memory, for example one of the memories 240 of FIG. 3 that is either directly connected to or distant from the particular processor. With reference to FIG. 2, memories within any of the tiles 120 could be the source of instructions. Still referring to FIG. 2, the instructions may even be stored outside of the core 112 (for example stored on an external memory) and routed to the particular processor through one of the I/O blocks 114. In other embodiments the external process may generate the instructions itself, and not retrieve instructions that have been previously stored. Channel execution mode extends the program size indefinitely, which would otherwise be limited by the size of the RAM 514.

A map register 506 allows a particular physical connection to be named as the input channel 502. For example, the input channel 502 may be an output of a multiplexer (not shown) having multiple inputs. A value in the map register 506 selects which of the multiple inputs is used as the input channel 502. By using a logical name for the channel 502 stored in the map register 506, the same code can be used independent of the physical connections.

In channel execution mode, the processor 500 receives a linear stream of instructions directly from the input channel 502, one at a time, in execution order. The decoder 510 accepts the instructions, decodes them, and executes them in a conventional manner, with some exceptions described below. In channel execution mode, the processor 500 does not require that the streamed instructions are first stored in RAM 514 before used, which would potentially destroy values in RAM 514 stored before execute-from-channel was started. Before being decoded by the decode 510, the instructions from the input channel 502 are stored in an instruction register 511, in the order in which they are received from the input channel 502.

An input channel 502 may be one formed by data/protocol registers 300 such as that illustrated in FIG. 4. In such a system, the data held in register 302 would be an instruction destined for execution by the processor 500. Depending on the length of the instruction, each data word stored in the register 302 may be a single instruction, a part of a larger instruction, or multiple separate instructions. As used in this application, the label “input channel” may include any form of processor instruction delivery mechanism that is different than reading data from the RAM 514.

Because of the backpressure flow control mechanisms built into each data/protocol register 300 (FIG. 4), the processor 500 controls the rate at which instructions flow into the processor through the input channel 502. For instance, the processor 500 may be able to accept a new instruction on every clock cycle. More typical, however, is that the processor 500 may need more than one clock cycle to perform some of the instructions received from the input channel 502. In that case, an input controller 504 of the processor 500 would de-assert an “accept” signal, stopping the flow of instructions. When the processor 500 is next able to accept a further instruction, the input controller 504 asserts its accept signal, and the next instruction is taken from the input channel 502.

Specialized instructions for the processor 500 allow the processor to change from one execution mode to another, e.g., from memory execution mode to channel execution mode, or vice-versa. A mode-switching instruction is callch, which forces the processor to stop executing from memory and switch to channel execution. When a callch instruction is executed by the processor 500, the states of the program counter 508 and mode register 513 are stored in a link register 550. Additionally, a mode bit is written into a mode register 513, which in turn causes a selector 512 to get its next instruction from the input channel 502. A return instruction changes the processor 500 back to the memory execution mode by re-loading the program counter 508 and mode register 513 to the states stored in the link register 550. If a return instruction follows a callch instruction, the re-loaded mode register 513 will switch the selector 512 back to receive its input from the RAM 514.

While the processor 500 is in channel execution mode, two other instructions, jump and call, automatically cause the processor to switch back to memory execution mode. Like callch, when a call instruction is executed by the processor 500, the states of the program counter 508 and mode register 513 are stored in a link register 550. Additionally, a mode bit is written into a mode register 513, which in turn causes a selector 512 to receive its input from the RAM 514. Because instructions from the input channel 502 are received as a single stream, and it is impossible to jump arbitrarily within the stream, both jump and call are interpreted as memory execution modes. Thus, if the processor 500 is in channel execution mode and executes a jump or call instruction, the processor 500 switches back to memory execution mode.

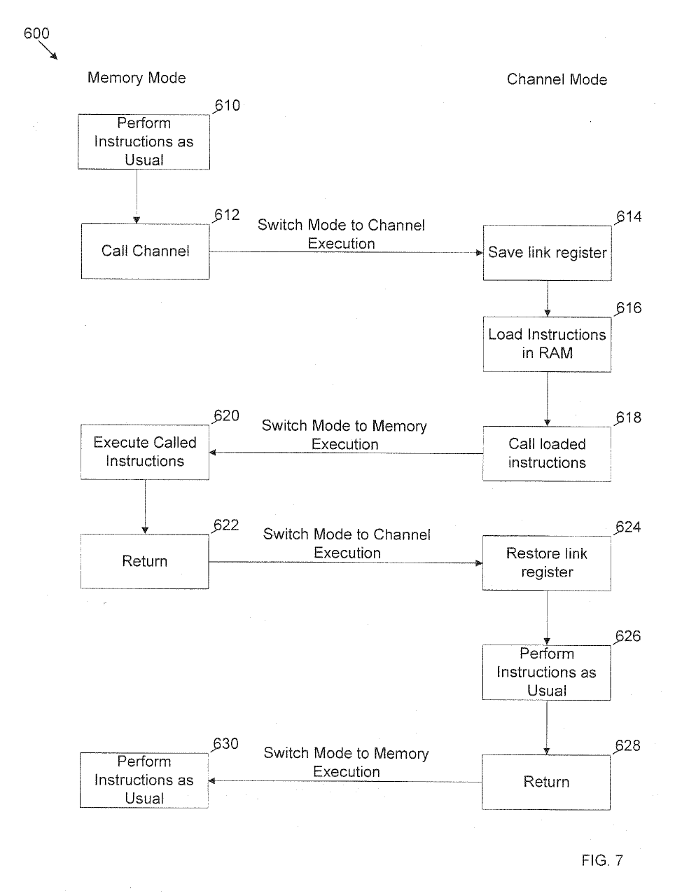

FIG. 7 illustrates an example of switching execution modes. A flow 600 begins with a processor 500 in memory execution mode in a process 610, executing local code. A callch instruction is executed in process 612, which switches the processor to channel execution mode. The state of the program counter 508 and mode register 513 are stored in the link register 550, and the mode register 513 is updated to reflect the new operation mode. The new link register 550 contents are saved in, for example, one of the registers 532, for later use, in a process 614.

Once in channel execution mode, the processor 500 operates from instructions from the input channel 502. If, for example, the programmer wishes to execute a loop of instructions, which is not possible in execute from channel mode, the programmer can load those instructions to a particular location in the RAM 514 in a process 616, and then call that location for execution in a process 618. Because the call instruction is by definition a memory execution mode process, the process 618 changes the mode register 513 to reflect that the processor 500 is back in memory execution mode, and the called instructions are executed in a process 620. After completing the called instructions, a return instruction while in memory execution mode causes the processor 500 to switch back to channel execution mode in a process 622. When back in channel execution mode, the process 624 restores the link register 550 to the state previously stored in the process 614. Next instructions are performed as usual in a process 626. Eventually, when the programmer wishes to change back to memory execution, another return instruction is issued in a process 628, which returns the processor 500 back to memory execution mode.

In addition to not being able to jump or call in channel execution mode, branching instruction flow while in channel execution mode is limited as well. Because the instruction stream from the input channel 502 only moves in a forward direction, only forward branching instructions are allowed in channel execution mode. Non-compliant or intervening instructions are ignored. In some embodiments of the invention, executing the branch command does not switch execution modes of the processor 500.

Additionally, multi-instruction loops that can be easily managed in the typical memory execution cannot be managed by a linear stream of instructions. Therefore, in channel execution mode, only loops of a single instruction can be considered legal instructions without extra buffering. Thus, looping a single instruction is the equivalent to executing a single instruction multiple times.

In some embodiments of the invention, all of the processors 500 throughout the entire core 112 (FIG. 2) are initialized to start in channel execution mode. This allows an entire system to be booted and configured using temporary instructions streamed from an external source. In operation, when the core 112 is originally powered or reset, each of the processors throughout the core executes a callch instruction, which simply waits until a first configuration instruction is streamed in from the input channel 502. This mechanism has a number of advantages over traditional processor configuration code. For instance, there is no special hardware-specific loading mechanisms needed to be linked in at compile time, the configuration can be as large or complex as desired, and yet consumes no local memory of the processor.

Another mode of operation uses a fork element 516 of FIG. 6 to duplicate instructions. If the mapping register 518 is appropriately set, code duplicated by the fork 516 is sent to the output register 520. The output register 520 of a particular processor 500 may connect to an input channel 502 of another processor. Thus, multiple processors can all execute the same stream of instructions as for Single Instruction Multiple Data (SIMD) systems. The synchronization of such a SIMD multi-processor system can be effected either implicitly through the topology of how the configuration instructions flow, or explicitly using transmitted messages on other channels by placing channel reads and writes in the configuration instructions.

Various components of the processor 500 may be used to support the ability of the processor to support having two execution modes. For example, instructions or data from an input channel 522 can be directly loaded into the RAM 514 by appropriately setting selectors 566, and 546. Further, any data or instructions generated by the ALU 530, registers 532, or an incrementing register 534 can be directly stored in the RAM 514. Additionally, a “previous” register 526 stores data from a previous processing cycle, which can also be stored into the RAM 514 by appropriately setting the selectors 566 and 546. In essence, any of the data storage elements or processing elements of the processor 500 can be arranged to store data and/or instructions into the RAM 514, for further operation by other execution elements in the processor. All of these procedures directly support the memory execution mode for the processor 500. When this flexibility of memory execution mode is combined with the ability to execute instructions directly from an input channel, it is possible to program the processor very efficiently and effectively in normal operation.

Processor architecture can vary widely, and specific implementations described herein are not the only way to implement the invention. For instance, sizes of the RAM, registers, and configuration of ALUS, and architecture of various data and operation paths may all be variables left up to the implementation engineer. For instance, the major processor 434 of FIG. 5 could have several and pipelined ALUs, double width instruction set, larger RAM, and additional registers as compared to the processor 500 of FIG. 6, yet still include all of the components to implement a multi-source processing system that accords to embodiments of the invention.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A processor, comprising:
a memory subsystem having random access to instructions stored in a memory;
a streaming channel input, separate from the memory subsystem, for streaming instructions to the processor from a streaming channel; and
a selector coupled to the memory subsystem and to the streaming channel input, the selector structured to choose an instruction from either the memory or the streaming channel.

2. The processor of claim 1 in which the streaming channel originates outside of the processor and comprises:
data elements for transmitting instructions to the processor; and
protocol signals for controlling a flow rate of instructions to the processor.

3. The processor of claim 2 in which the streaming channel originates from a memory external to the processor.

4. The processor of claim 2, further comprising:
an input controller coupled to the streaming channel and structured to generate at least one of the protocol signals.

5. The processor of claim 4 in which the input controller is structured to generate a separate protocol signal for each single instruction streamed to the processor.

6. The processor of claim 1, further comprising:
a mode indicator structured to store an indication of one of at least two modes in which the processor is structured to operate.

7. The processor of claim 6 in which one of the modes is channel execution.

8. The processor of claim 6 in which the selector is structured to be controlled by the mode indicator.

9. The processor of claim 1 in which the processor is structured to operate in a first mode when the selector chooses an instruction from the memory and structured to operate in a second mode when the selector chooses an instruction from the streaming channel.

10. The processor of claim 9, further comprising a mode selector structured to change processor operation modes when the mode selector receives a mode change signal.

11. The processor of claim 10 in which the mode change signal is an instruction.

12. A system of multiprocessors, comprising:
a plurality of processors,
a communication fabric interconnecting the plurality of processors, the communication fabric including a series of communication channels having data lines and protocol lines;
at least one random access memory having instructions stored therein;
wherein at least one of the plurality of processors includes:
a memory input for accepting instructions from the random access memory;
a channel input coupled to a selected one of the communication channels that is structured to stream instructions to the processor; and
a selector coupled to the memory input and to the channel input and structured to choose an instruction from either the random access memory or the communication channel.

13. The system of claim 12 in which the random access memory is contained within the at least one processor.

14. The system of claim 12 in which the at least one processor further comprises:
an input controller coupled to the channel input and structured to control the protocol lines of the selected communication channel.

15. The system of claim 14 in which the input controller is structured to transmit a separate protocol signal for each single instruction streamed to the processor.

16. The system of claim 12 in which the selected one of the communication channels is a unidirectional channel.

17. The system of claim 12, further comprising:
a mode indicator structured to store an indication of one of at least two modes in which the at least one processor is structured to operate.

18. The system of claim 17 in which one of the modes is channel execution.

19. The system of claim 18 in which the mode indicator is structured to drive the selector with the mode indicator.

20. The system of claim 19 in which the mode indicator is structured to change when the processor receives a mode change signal.

21. The system of claim 20 in which the mode change signal is an instruction.

22. A method of operating a processor, comprising:
executing an instruction from a first instruction source;
receiving a signal to change execution modes; and
executing an instruction from a second instruction source, wherein at least one of the sources is an instruction stream.

23. A method according to claim 22 in which executing an instruction from a first instruction source comprises executing an instruction from a memory.

24. A method according to claim 22 in which executing an instruction from a second instruction source comprises executing an instruction from a channel.

25. A method according to claim 24 in which the channel is unidirectional.

26. A method according to claim 22 in which executing an instruction from a second instruction source comprises executing an instruction from a streaming channel that was selected from a plurality of channels.

27. A method according to claim 22, further comprising, after receiving the signal to change execution modes, storing a signal in a mode indicator.

28. A method according to claim 22 in which receiving a signal to change execution modes comprises receiving an instruction to change execution modes.

29. A method according to claim 22 in which receiving an instruction to change execution modes comprises receiving an instruction that is valid in a memory execution mode and in a channel execution mode.

30. A method of operating a processor, comprising:
operating in a channel execution mode using instructions from a channel;
storing instructions that were received from the channel into a memory; and
switching to a memory execution mode to operate on the instructions from the memory.

31. A method according to claim 30, further comprising, before switching to the memory execution mode:
receiving a mode-switching signal.

32. A method according to claim 31 in which receiving a mode-switching signal comprises receiving a processor instruction.

33. A method according to claim 32 in which the processor instruction was received from the channel.

34. A method of operating a processor according to claim 30, further comprising:
selecting an instruction channel from more than one instruction channel.
